(19) United States
(12) Patent Application Publication
(10) Pub. No.: US 2026/0099890 A1
(43) Pub. Date: Apr. 9, 2026

(54) TEXTUAL DATA CONTEXT ASSESSMENT ENGINE WITH SUBSYSTEM ARCHITECTURE

(71) Applicants: David Kerman, Frisco, TX (US); Thomson Reuters Enterprise Centre GmbH, Zug (CH); Thomson Reuters Canada Limited, Toronto (CA)

(72) Inventors: Gayle May McElvain, Minneapolis, MN (US); Carol Jo Steffen Lechtenberg, St. Paul, MN (US); Benjamin Petersburg, Bloomington, MN (US); Brian Charles Phillips, Lakeville, MN (US); Masooma Ali, Milton (CA); Pawel Urbanski, Lomna (PL); David Brickerman, Frisco, TX (US); Merine Thomas, Eagan, MN (US)

(21) Appl. No.: 19/354,414

(22) Filed: Oct. 9, 2025

Related U.S. Application Data
(60) Provisional application No. 63/705,364, filed on Oct. 9, 2024.

(51) Int. Cl. G06Q 50/18; G06F 18/213; G06F 40/289; G06F 40/40

(52) U.S. Cl. CPC G06Q 50/18; G06F 18/213; G06F 40/289; G06F 40/40

(57) ABSTRACT

Systems, methods, and devices disclosed herein include a textual data context assessment engine. A system can extract a set of data segments from input data, wherein the input data comprises information associated with one or more legal authority documents. Then the system can identify a set of features in the set of data segments being related to source data contained in the legal authority documents. Also, the system can receive an input document including data for verification, wherein the data for verification includes a portion of the data contained in the legal authority documents. Next, the system can determine at least one of an omission, an addition, a change, or accurate characterization in the data for verification by comparison to the data contained in the legal authority documents.

### CROSS-REFERENCE TO RELATED APPLICATION

This application claims priority to U.S. Provisional Patent Ser. No. 63/705,364, titled “QUOTATION, CONTEXT AND STATEMENT MISCHARACTERIZATION DETECTION IN LEGAL DOCUMENT REVIEW” filed Oct. 9, 2024, the entirety of which is incorporated by reference.

### BACKGROUND

Attorneys have a duty to zealously advocate for their clients, so they may inaccurately quote or misinterpret textual data, either intentionally or unintentionally, to fit an advocacy position. In parties'court filings, primarily briefs and trial court memoranda, there may be differences - between the language in the filing and the language in the specific quote from cited cases used to support client arguments. But there are also instances where the difference between the court filing and the supporting cited cases aren't in specific quotes at all. There may be instances when the law may not favor a client's desired outcome and the attorney stretches their interpretation of the law or they cleverly omit the full context of their supporting cases in the hopes of being successful before the court. Other times, the law is complex and attorneys just get their legal interpretations wrong.

Although some software products exist to analyze legal documents, the underlying backend operations of these software products are computationally intensive and require significant processing and memory storage resources. Moreover, these types of legal analysis tools have backend frameworks with complex and rigid data structures that make integration into multiple different types of software platforms challenging. Further difficulties arise when certain subcomponents of the backend framework become out of date because upgrading one subcomponent of the backend causes additional downstream affects to other subcomponents, which requires further resources to address.

### SUMMARY

The systems, methods, and devices disclosed herein can address the aforementioned issues. For instance, a system can include a memory; and one or more processors coupled to the memory, the one or more processors configured to perform steps, comprising extracting, by the one or more processors, a set of data segments from input data, wherein the input data comprises information associated with one or more legal authority documents; identifying, by the one or more processors, a set of features in the set of data segments extracted from the input data, the set of features being related to source data contained in the legal authority documents; receiving, by the one or more processors, an input document including data for verification, wherein the data for verification includes a portion of the data contained in the legal authority documents; determining, by the one or more processors, at least one of an omission, an addition, a change, or accurate characterization in the data for verification by comparison to the data contained in the legal authority documents; and/or outputting, by the one or more processors, a report of the at least one mischaracterization in the data for verification in comparison to the data contained in the legal authority documents for a user.

In some examples, the input document can include a textual document uploaded to a textual data context assessment engine executed by the one or more processors. Also, the data for verification can include one or more textual quotations and one or more citations associated with the one or more textual quotations. The one or more processors can be further configured to perform steps comprising executing a natural language processor that uses a set of position and distance rules to identify a legal proposition corresponding to the one or more textual quotations. Also, the set of features can include data from a cited document which corresponds to the data for verification. Furthermore, the determining of the at least one mischaracterization in the data for verification can include providing the set of features and the data for verification to a large language model (LLM) with a prompt to identify any mischaracterizations between the set of features and the data for verification. The prompt can include a formatting instruction to generate an output having a length of two to four lines. Additionally, the one or more processors can be further configured to perform steps comprising generating a graphical user interface (GUI) to present a visualization of the report. The GUI can include a first section that presents an assessment summary of the report and one or more additional sections which present at least one of the set of features or the data for verification.

In some scenarios, a system can include a memory; and one or more processors coupled to the memory, the one or more processors can be configured to perform steps comprising identifying, by the one or more processors, data for verification from an uploaded data file representing an input document, the data for verification including at least a textual quotation, a legal proposition, and a citation related to a cited document; extracting, by the one or more processors, a set of data segments from input data corresponding to the cited document; identifying a set of features in the set of data segments extracted from the input data, the set of features including context data corresponding to a legal authority document; determining, by the one or more processors, at least one relationship (e.g., a mischaracterization or accurate characterization) in the data for verification by comparison to the set of features; and/or outputting, by the one or more processors, a report of the at least one relationship (e.g., a mischaracterization including one or more of an addition, an omission, or a change) in the data for verification in comparison to the data contained in the cited document for a user.

In some cases, the one or more processors can be configured to perform steps comprising causing a graphical user interface (GUI) to be presented at a display of a computing device, the GUI presenting a visual representation of one or more portions of the report. The GUI can include a first section including an assessment summary of the report indicating the at least one of the omission, the addition, or the change in the data for verification. Also, the GUI can include a first column of presented data and a second column of presented data. The first column can include data from the input document and the second column can include data from the cited document, and the first column and the second column can be arranged at the GUI below the first section including the assessment summary.

In some scenarios, the first column can include a visual presentation of the data for verification. Additionally, the visual presentation of the data for verification can include a first visual indicator of the textual quotation and a second visual indicator of the legal proposition. Moreover, the second column can include a visual presentation of the set of features from the input data. The visual presentation of the set of features can include a first visual indicator of corresponding text from the cited document and a second visual indicator of context data associated with the corresponding text. The GUI can include presentation of a quotation type selector element which, upon receiving a user input, causes textual quotations presented at the GUI to be filtered based on whether the textual quotations are matched, by the one or more processors, with corresponding texts from cited documents. Furthermore, the GUI can include presentation of a severity sort element which, upon receiving user input, sorts a plurality of textual quotations presented a the GUI based on potential severity of mischaracterization values associated with a plurality of textual quotations.

In some examples, a method can include extracting, by one or more processors, a set of data segments from input data, wherein the input data comprises information associated with one or more legal authority documents; identifying, by the one or more processors, a set of features in the set of data segments extracted from the input data, the set of features being related to source data contained in the legal authority documents; receiving, by the one or more processors, an input document including data for verification, wherein the data for verification includes a portion of the data contained in the legal authority documents; determining, by the one or more processors, at least one of an omission, an addition, a change, or accurate characterization in the data for verification by comparison to the data contained in the legal authority documents; and/or outputting, by the one or more processors, a report of the at least one of the omission, the addition, or the change in the data for verification in comparison to the data contained in the legal authority documents for a user.

### BRIEF DESCRIPTION OF THE FIGURES

FIG. 1 illustrates an example system including a textual data context assessment engine for generating an additional data layer associated with quotes extracted from a text data file.

FIGS. 2A and 2B illustrates an example system including a textual data context assessment engine with a graphical user interface (GUI) including a module access element.

FIG. 3 illustrates an example system including a textual data context assessment engine with a results graphical user interface (GUI) to present an arrangement of visual representations and interactive GUI elements.

FIG. 4 illustrates an example system including a networked environment for implementing a textual data context assessment engine.

FIG. 5 illustrates an example method of using a textual data context assessment engine, which can be performed by using any of the system(s) of FIG. 1-4.

### DETAILED DESCRIPTION

It will be appreciated that numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts may be exaggerated to better illustrate details and features of the present disclosure.

The systems, methods, and devices disclosed herein can include a textual data context assessment engine for generating an additional data layer associated with features extracted from a text data file. The textual data context assessment engine can be used to analyze various types of documents, such as legal documents, to assess a validity of contextual propositions in the documents.

The task of reviewing documents for mischaracterizations (e.g., omissions, additions, or changes) of the law, either in direct quotes or contextually, is both time-consuming and prone to error. Furthermore, instances where attorneys paraphrase statements throughout the argument sections of their briefs open their arguments up to more misstatements and misinterpretations. The differences in language and context can often be slight—the difference between using must and may—and often nuanced with savvy advocates selectively quoting supporting cases. Beyond being a time-intensive task, missing a contextual or quoted misstatement in a brief can have expensive real-world consequences and puts attorneys at risk. Attorneys must be aware of their opponents'mistakes so they can best advocate for their clients, but they also want to ensure that they are not making mistakes either to avoid any harm to their own credibility or reputation - or worse yet, possible sanctions from the court. Moreover, the judiciary needs to be able to review parties'documents as efficiently as possible.

The technology disclosed herein provides a novel approach for identifying relationships between input documents and legal authority documents cited in the input documents, such as potential mischaracterizations of the cited documents (e.g. or confirming that the relationship between the input document and the legal authority document cited therein is an accurate characterization). The algorithms disclosed herein can employ a unique combination of natural language processing (NPL) techniques with large language model (LLM) prompting that use text and language similarity (among other parameters) to align identified textual quotations from the uploaded document with the corresponding cited case. The result is a highly accurate analysis of the quotes in the document for attorneys to review. Moreover, the underlying data scheme disclosed herein is highly scalable with a modular subsystem architecture that efficiently converts input data into output data, which can be further converted into graphical user interface components in a way that reduces processing requirements, memory storage requirements, and energy usage of the device executing the software. Additionally, the disclosed data structure enables for easy upgrading of various subcomponents as improvements to LLMs and NPL modules become available, without requiring significant downstream adjustments. As such, the technology disclosed herein can improve the underlying operation of the computer executing the software while increasing the simplicity with which additional/upgraded components can be integrated.

As such, the technology disclosed herein can provide scalable and upgradable algorithmic components with the ability to be alerted to mischaracterizations with more sophistication beyond highlighted language changes in direct quotes—to be told when quotes were taken out of context or holdings of cited cases were misconstrued. The combination of subsystems disclosed herein can address the processing and coding challenges of integrating direct quotation and context review software subsystems into a wide variety of different software platforms, and the organizational architecture can simplify the process for upgrading/replacing/improving subcomponents in a way that will cause the software to avoid obsolescence over time. This technology combines the considerable linguistic competence of large generative language models with relevance signals from the ensemble technique developed for quotation analysis. The following disclosure details an operational framework to streamline complex quotation and contextual analysis workflows, while improving on overall accuracy and ease of use.

Additional advantages of the systems, methods, and devices disclosed herein will become apparent from the detailed description below.

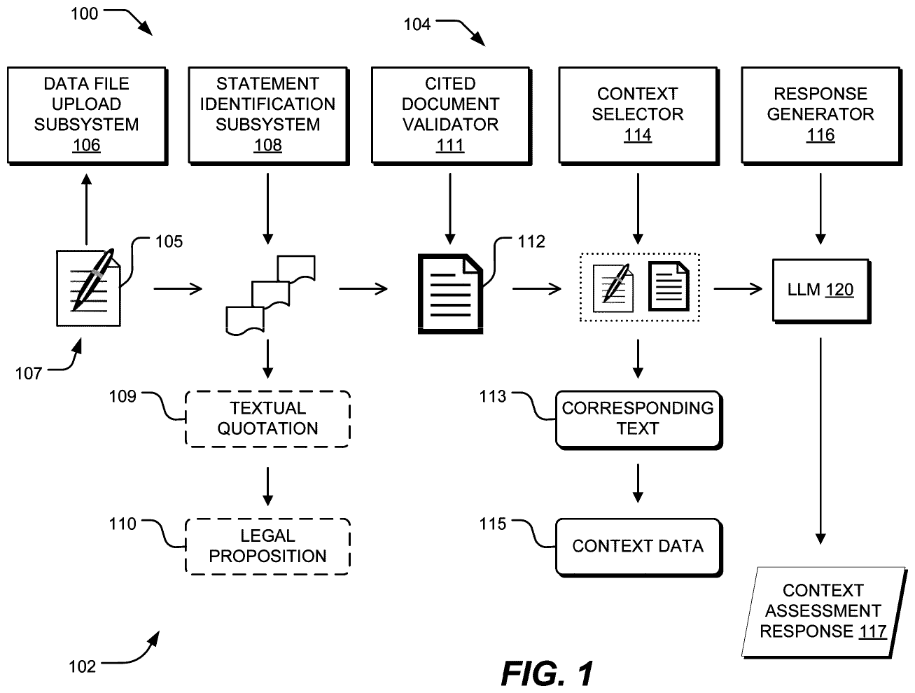

FIG. 1 illustrates an example system 100 including a textual data context assessment engine 102 for generating an additional data layer associated with quotes extracted from a text data file using a unique data subsystem architecture. The disclosed textual data context assessment engine 102 can be designed with modularity designed for optimal integration into various software platforms, as discussed in greater detail below.

In some examples, the textual data context assessment engine 102 can include a plurality of subsystems 104 which interact together in a unique way to generate and/or present the additional data layer associated with quotes extracted from a text data file. For instance, the textual data context assessment engine 102 can include a data file upload subsystem 106 for receiving an uploaded document 105 (e.g., input data 107), a statement identification subsystem 108 for identifying textual quotations 109 and/or legal propositions 110 associated with the textual quotation 109, and a cited document validator 111 to identify cited documents 112 associated with the textual quotations 109 and detect and differences between the textual quotation 109 and the corresponding text 113 of the identified cited document 112. Additionally, the textual data context assessment engine 102 can include a context selector 114 to extract context data 115 from the identified cited document 112 associated with the corresponding text 113. Furthermore, the textual data context assessment engine 102 can include a response generator 116 which generates a context assessment response 117 characterizing the textual quotation 109 and the legal propositions 110 with respect to the extracted context data 115, and indicates any discrepancies or mischaracterizations of the extracted context data 115. Each of these subsystems 104, and the way they interact together to seamlessly provide data to frontend user interfaces, are discussed in greater detail below.

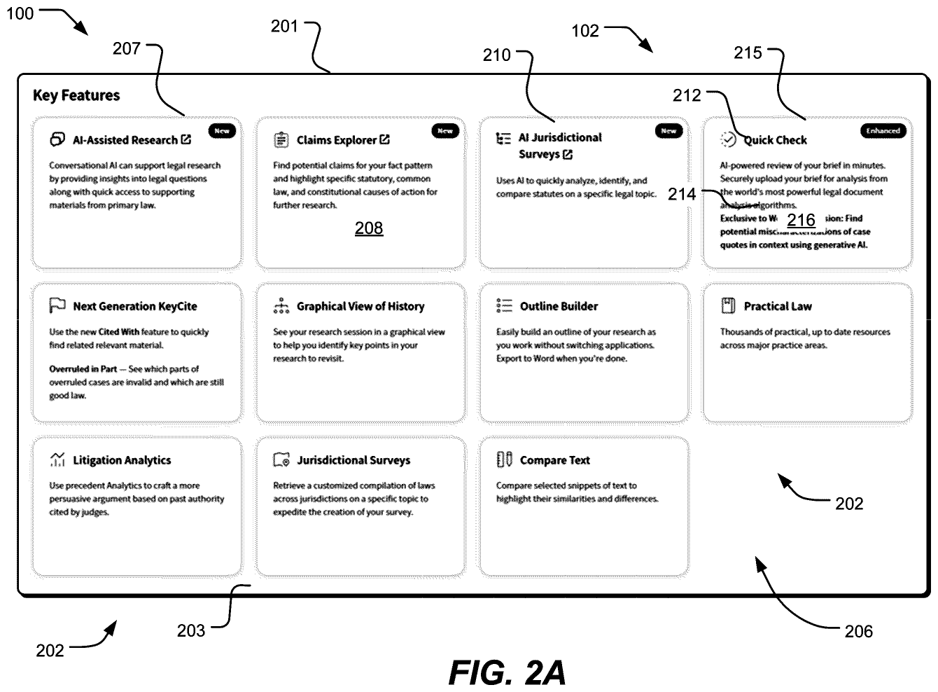

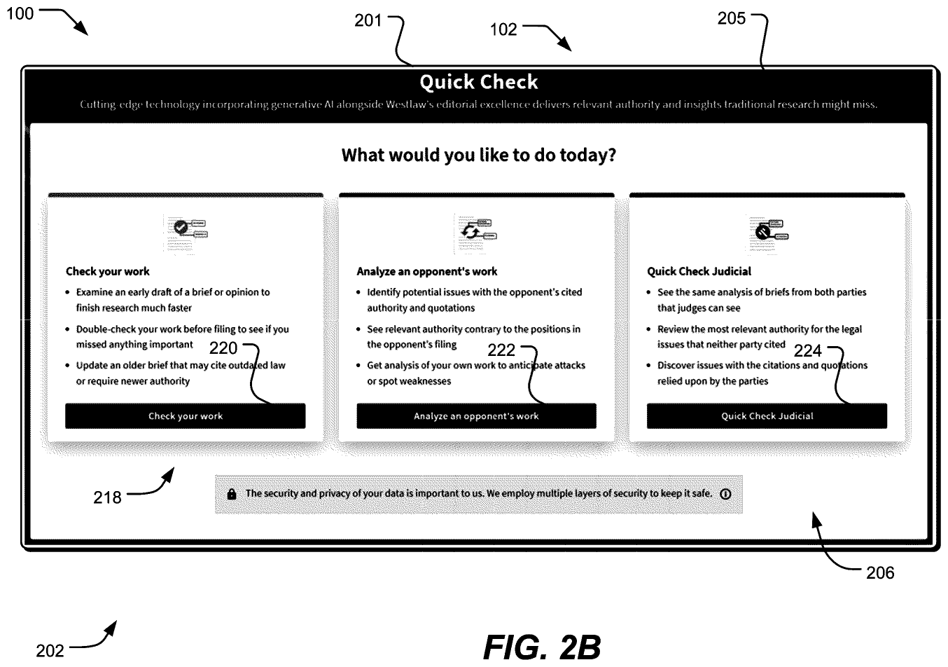

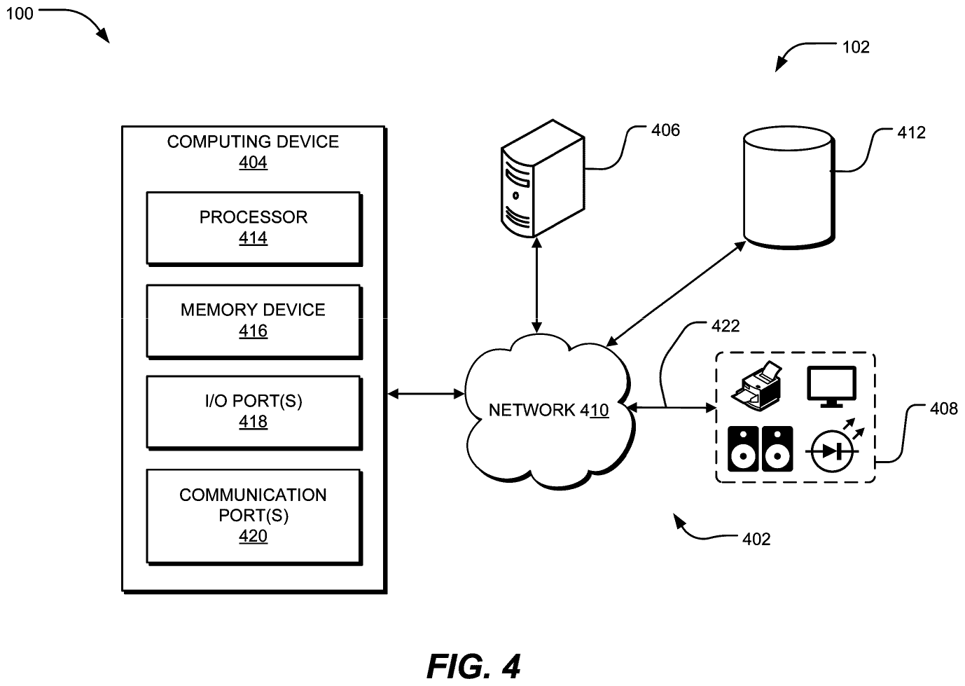

In some scenarios, the textual data context assessment engine 102 can include the data file upload subsystem 106 for receiving the input data 107 (e.g., data for verification). The input data 107 can be any data file including text data, such as a word document or a PDF, and can include a legal brief, legal memo, pleading, legal opinion, or so forth. In some cases, the data file upload subsystem 106 can include an interactive GUI element which, upon receiving a user input, opens a data file upload field or window. Additionally or alternatively, receiving the user input at the data file upload subsystem 106 may include activating a camera application for providing the input data 107 as image data collected by the camera application, or may include activating a microphone application for receiving the input data 107 as an audio input (e.g., voice input spoken by the user). The various types of external physical systems that may implement the disclosed technology are discussed in greater detail below regarding FIG. 4 (e.g., including external physical systems 408). The data file upload subsystem 106 may be presented at a GUI (e.g., GUIs 202 and/or 302 of FIGS. 2 and/or 3) in response to a user input at a module access element (e.g., module access element 216 of FIG. 2A) which can be used to access the textual data context assessment engine 102 and/or initiate the operations of the textual data context assessment engine 102.

In some cases, the textual data context assessment engine 102 can include the statement identification subsystem 108 for identifying textual quotations 109 and/or legal propositions 110 associated with the textual quotation 109 (e.g., data for verification). This subsystem 104 can perform operations involving the identification of a data segment, such as a span of text in the uploaded document 105 that is likely relevant to a particular citation (e.g., the textual quotation 109). These extracted statements can be simple or composite sentences containing quotations from the cited document 112 or may paraphrase a legal proposition detailed in the cited document 112. This text can be extracted by the statement identification subsystem 108 using a combination of rule-based algorithms, natural language processing (NLP) techniques, and Large Language Models (LLMs). The statement identification subsystem 108 can use in-context learning along with prompts developed by subject matter experts to leverage LLMs to perform this task. For statements not restricted to quotations, the input to the LLM can be based on a segmentation algorithm that identifies sections of the uploaded document 105 that detail the key arguments being made to the court.

Additionally, LLMs of the statement identification subsystem 108 may be fine-tuned to extract and/or refine these statements from the uploaded document 105 and classify the intent of the citation and the statement type according to taxonomies developed by subject matter experts.

In some scenarios, the textual data context assessment engine 102 can include the cited document validator 111 to identify the cited documents 112 (e.g., segments of data) associated with the textual quotations 109 and detect differences between the textual quotation 109 and the corresponding text 113 (e.g., a feature from the segments of data) of the identified cited document 112. For instance, once a textual quotation 109 and/or legal proposition 110 (e.g., statement of context) is identified, the next step can be to validate the citation for the textual quotation 109 that should be associated with legal proposition 110. Multiple citations can be suitable candidates for a given statement and the task of the cited document validator 111 can be to identify the best citation to be associated with the legal proposition 110 (e.g., statement of context). Various natural language processing techniques that use lexical and semantic similarity along with a set of position and distance based rules can be employed to align the legal proposition 110 (e.g., statement of context) from the uploaded document 105 with a single cited document 112 from the pool of candidates. For legal proposition 110 containing quotations from cited cases, the cited document validator 111 can identify the exact location of the quoted text, the corresponding text 113, in the identified cited case 112 and can detect any lexical differences between the textual quotation 109 in the uploaded document 105 and language as it appears in the identified cited case 112.

In some examples, the textual data context assessment engine 102 can include the context selector 114 to extract the context data 115 (e.g., one of the features of a set of features) from the identified cited document 112 (e.g., and/or a segment of data from the cited document) associated with the corresponding text 113. To determine if the legal proposition 110 (e.g., statement of context) in the uploaded document 105 mischaracterizes the cited document 112, the context data 115 extracted from the cited document 112 will be compared against the legal proposition 110 (e.g., statement of context). On the uploaded document 105 side, the textual data context assessment engine 102 can use a rule-based algorithm to extract context data from the proximity of the extracted statement. This context data can be further enhanced using an LLM generated summary of facts and statements of law from the rest of the uploaded document 105. Additionally, on the cited document 112 side, for statements with quotations, the context selector 114 can use the location of the matched quoted text, the corresponding text 113, to extract relevant context data 115. For other types of statements, context from the cited document 112 can be extracted by applying a passage level relevance model to identify the most relevant passages and/or spans of text in the cited document 112 in relation to the legal proposition 110 (e.g., statement of context). This passage level relevance model can be a cross-encoder that is trained to predict the likelihood of a chunk of text being relevant to a citation in another document.

In some cases, the textual data context assessment engine 102 can include the response generator 116 to generate the context assessment response 117 characterizing the textual quotation 109 and the legal propositions 110 with respect to the extracted context data 115 from the identified cited document 112. For instance, the legal proposition 110 (e.g., statement of context) from the uploaded document 105 and the cited document 112 along with the context data 115 can be combined with task specific instructions 118 to form the input for an LLM 120 for sequence generation, for example, to identify mischaracterizations (e.g., additions, changes, omissions, or other inaccuracies) in the textual quotation 109 and/or the legal propositions 110 with respect to the corresponding text 113 and/or the context data 115 from the cited document 112. Multiple prompts can be used based on the type of legal proposition 110 and, should a mischaracterization be detected, additional prompts can be generated and provided to the LLM 120 to both generate a description of the inaccuracy and determine its substantiveness.

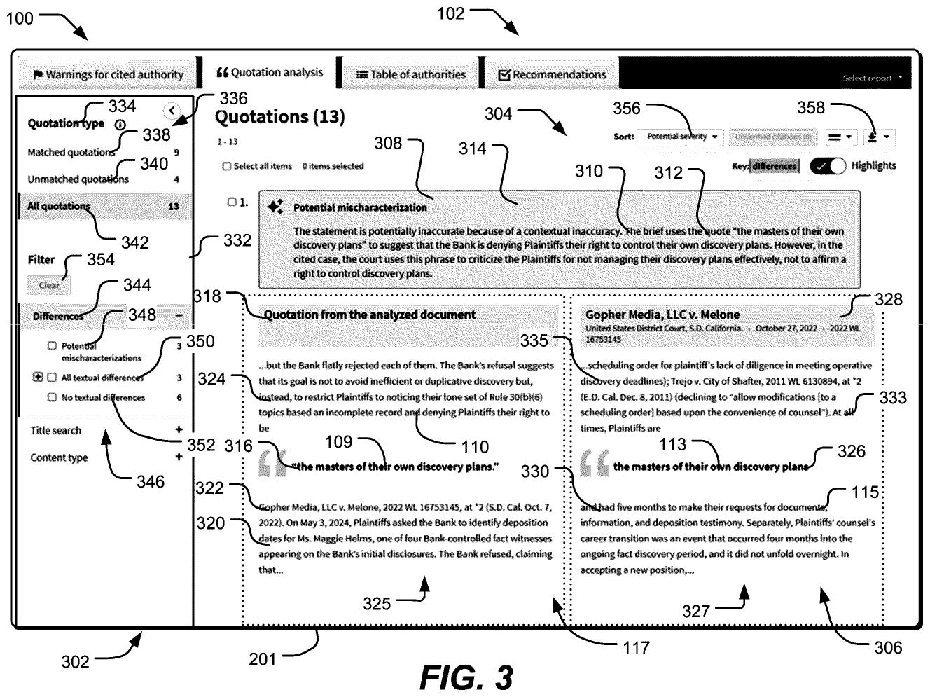

In some cases, the prompts, which can be developed by subject matter experts and/or generated by supplemental machine learning-based models, can leverage in-context learning, can be stored at one or more database(s) (e.g., databases 412 of FIG. 4), and can be retrieved by the response generator 116. Additionally, the structure of the context assessment response 117 may be templated based on the type of statement and the category of mischaracterization identified. For instance, an addition-type mischaracterization may result in a context assessment response 117 which indicates the additional portion of data, an omission-type mischaracterization may result in a context assessment response 117 which indicates the omitted portion of data, and/or a change-type mischaracterization can result in a context assessment response 117 which indicates the changed portion of data. Moreover, the prompt(s) provide to the LLM 120 can be templated based on the category of mischaracterization. For instance, the textual data context assessment engine 102 can implement a first prompt template specifically corresponding to a first type of mischaracterization being an addition-type mischaracterization (e.g., “describe any additional information present in the legal proposition 110 relative to the context data 115”), a second prompt template specifically corresponding to a second type of mischaracterization being an omission-type mischaracterization (e.g., “describe any missing information present in the legal proposition 110 relative to the context data 115), and/or a third prompt template specifically corresponding to a third type of mischaracterization Additionally, some scenarios can include a minimum response length, provided by the prompt(s), to contain a 2-4 line description of the mischaracterization and its potential impact. If a potential mischaracterization is identified, a summary of the mischaracterization, generated by the LLM 120 based on the prompt(s) and/or the input data, can be included in the context assessment response 117, and can be shown to the user alongside the input data, such as the characterizations (e.g., the legal proposition 110) from the uploaded document 105 and the context data 115 from the cited document 112 (e.g., as shown in FIG. 3). For the case of quotation based statements, any identified lexical differences can also be identified by the response generator and indicated (e.g., highlighted) in the context assessment response 117.

FIGS. 2A and 2B illustrate an example system 100 including the textual data context assessment engine 102 with one or more graphical user interfaces (GUI)s 202, presented at a display 201, which can be used to integrate the textual data context assessment engine 102 with another software platform 204.

In some examples, the textual data context assessment engine 102 can be deployed as a submodule or subsystem of another software platform 204, such as a legal document analysis platform 206 with a wide variety of features and modules. However, due to the data schema and subsystem structure of the textual data context assessment engine 102 (e.g., the division of functionalities into the subsystems 104, discussed above) the textual data context assessment engine 102 can be highly versatile in its deployment scenarios. The software platform 204 integrating the textual data context assessment engine 102 (e.g., and/or one or more subsystems 104 of the textual data context assessment engine 102) can include the legal document analysis platform 206, or a different type of software platform 204, such as an educational grading tool, an auditing/reporting tool, a financial documents analysis tool, or combinations thereof. The high-efficiency subsystem data architecture of the textual data context assessment engine 102 provides increased use-case viability among a wide range of industries.

In some examples, the GUI(s) 202 can include a first feature selector GUI 203 (e.g., of the legal document analysis platform 206). The first feature selector GUI 203 can present a plurality of interactive GUI elements 207 which each correspond to a particular software subsystem (e.g., “feature”) of the software platform 204. The plurality of interactive GUI elements 207 can include a plurality of tiles 208 having substantially uniform dimensions presented at the first feature selector GUI 203. Individual interactive GUI elements 210 of the plurality of interactive GUI elements 207 can include a subsystem label 212 (e.g., “AI-Assisted Research,” “Claims Explorer,” AI Jurisdictional Surveys,” “Quick Check,” “Next Generation KeyCite,” “Graphical View of History,” “Outline Builder,” “Practical Law,” “Litigation Analysis,” “Jurisdictional Surveys,” “Compare Text,” etc.) and/or a subsystem summary 214 presented below the subsystem label 212.

Additionally, a particular interactive GUI element 215 of the plurality of interactive GUI elements 207 can function as a module access element 216 for the textual data context assessment engine 102. Receiving a user input at this particular interactive GUI element 214 can cause the functionalities of the textual data context assessment engine 102 to be presented at the GUI(s) 202, such as the data file upload subsystem 106 and/or the interactive GUI element for initiating the upload of the upload document 105 and/or the input data 107. Additionally, or alternatively, receiving the user input at the module access element 216 can trigger any of the other functionalities of the subsystems 104 of the textual data context assessment engine 102, for instance, by using an uploaded document 105 and/or input data 107 received at one of the other software subsystems represented by the plurality of interactive GUI elements 207.

In this way, the arrangement and access to software platform subsystems can be highly efficient and user friendly, reducing data redundancies and improving the overall performance of the computing device executing the textual data context assessment engine 102. For example, the subsystem data structure can be organized into discrete modules which enable for easy upgrading when new NPL and/or LLM components become available, without causing negative impacts to downstream data management. Furthermore, this unique arrangement of software components provides for a highly efficient conversion of the output data into discrete GUI features which can be added, removed, and/or size-adjusted to match many different types of display devices, improving the ability for the textual data context assessment engine 102, and/or any subsystems 104 of the textual data context assessment engine 102, to be integrated into many different types of software platforms 204.

Turning to FIG. 2B, the GUIs 202 of the textual data context assessment engine 102 can include a second feature selector GUI 205. The second feature selector GUI 205 can be presented in response to the user input at the module access element 216, and/or the second feature selector GUI 205 can be presented in response to another user input at a different GUI 202 of the software platform 204. The second feature selector GUI 205 can present multiple workflow option selectors 218 for initiating the operations of the textual data context assessment engine 102. A first workflow option selector 220 can be presented at a first portion of the second feature selector GUI 205 and can present an option for assessing a data file of the user (e.g., “Check your work,”). A user input provided to this first workflow option selector 220 can inform the textual data context assessment engine 102 that the upload document 105 is likely authored by the user and/or a party associated with or represented by the user. This indication of origination of the upload document 105 can be used by the textual data context assessment engine 102 to trigger other downstream operations, such as influencing a word choice or phrase of the prompts for the LLM 120, or informing the data file upload subsystem 106 of which directory and/or database(s) 412 to access for the document upload procedure. Additionally, the second feature selector GUI 205 can present a second workflow option selector 222 presented at a second portion of the feature selector GUI 205, which presents an option for assessing a data file of an opponent. A user input provided to this second workflow option selector 222 can inform the textual data context assessment engine 102 that the upload document 105 is likely authored by an opposing party with respect to the user, which can influence a word choice or phrase of the prompts for the LLM 120, and/or can inform the data file upload subsystem 106 of which directory and/or database(s) 412 to access for the document upload procedure. Finally, the second feature selector GUI 205 can present a third workflow option selector 224 presented at a third portion of the feature selector GUI 205, which presents an option for focusing the operations of the textual data context assessment engine 102 on judicial authority assessments. For instance, a user input provided to this third workflow option selector 224 can cause the textual data context assessment engine 102 to assess two uploaded documents 105 (e.g., one from each party), find additional relevant legal authority documents missing from the uploaded documents 105 (e.g., which have similar or related context data to the context data 115 of the cited document 112), and/or initiate the operations of the statement identification subsystem 108, the cited document validator 111, the context selector 114, and/or the response generator 116.

FIG. 3 illustrates an example system 100 including a GUI 302 of the textual data context assessment engine 102. The GUI 302 can be organized into a plurality of sections 304 to present different outputs of the textual data context assessment engine 102.

In some examples, the GUI 302 can be a results GUI 306 which presents the context assessment response 117 with other data which improves a visualization layout for the textual data context assessment engine 102. For instance the context assessment response 117 can include an assessment summary section 308 presenting an assessment summary 310 outputted by the LLM 120. The assessment summary 310 can include a textual description 312 of a potential mischaracterization of the textual quotation 109 and/or legal proposition 110, as defined by the prompts provided to the LLM 120 and the input data provided to the LLM 120 (e.g., the textual quotation 109, the legal proposition 110, the corresponding text 113 from the cited document 112, and/or the context data 115 from the cited document 112). In some cases, the assessment summary 310 can be presented at a first section 314 of the GUI 302, which can be positioned near a top or upper half of the GUI 302. A second section 316 of the results GUI 306 can present the textual quotation 109 pulled from the uploaded document 105, for instance, with a first label 318 indicating that the textual quotation 109 is from the uploaded document 105 (e.g., “Quotation from analyzed document”). Moreover, the results GUI 306 can present, at a third section 320, an indication 322 of the cited document 112, which can be a hyperlink which, upon receiving a user input, redirects the GUI 302 to the text of the cited document 112. In response to receiving this user input and redirecting the GUI 302 to the text of the cited document 112, the textual data context assessment engine 102 can generate a visual indicator for the corresponding text 113 (e.g., highlighting and/or a color change), and/or a visual indicator of the context data 115 to supplement the visual presentation of the cited document 112.

Additionally, a fourth section 324 of the results GUI 306 can be presented which includes the legal proposition 110 from the uploaded document 105 and/or a summary of the legal proposition 110 (e.g., generated by the LLM 120). In some cases, the second section 316, the third section 320, and the fourth section 324 can be arranged on the results GUI 306 below the assessment summary 310 and/or forming a first column 325 below the first section 314 (e.g., at a first half of the results GUI 306).

Furthermore, the results GUI 306 can present, at a fifth section 326, the corresponding text 113 pulled from the cited document 112. This fifth section 326 can be presented next to and/or simultaneously with the second section 316 such that a user can easily compare the textual quotation 109 with the corresponding text 113. Also, a second label 328 can be presented with the fifth section 326 (e.g., above the fifth section 326) indicating the source of the corresponding text 113, such as the case citation of the cited document. Additionally, the context data 115 of the corresponding text 113 can be presented at a sixth section 330 (e.g., below the corresponding text 113). Additionally a case summary 333 of the cited document 112 can be presented at a seventh section 335. This context data 115 can be text in close proximity to the corresponding text 113 (e.g., either immediately preceding or immediately following) in the cited document 112, as identified by the context selector 114. The fifth section 326, the second label 328, the sixth section 330, and the case summary 333 can be presented below the assessment summary 310, forming a second column 327 below the first section 314 (e.g., at a second half of the results GUI 306). Using this particular layout, the first column 325 can be presented next to the second column 327, such that the fifth section 326 with the corresponding text 113 horizontally aligns and/or are simultaneously presented with the second section 316 with the textual quotation 109. Also, the sixth section 330 with the context data 115 of the cited document 112 can horizontally align with and/or can be simultaneously presented with the fourth section 324 with the legal proposition 110. With this GUI layout of the results GUI 306, the data accessed and generated by the textual data context assessment engine 102 can be visualized in a highly efficient manner. Furthermore, by presenting the legal proposition 110 and the context data 115 in addition to the textual quotation 109 and corresponding text 113, nuanced differences between the meaning of the textual quotation 109 and corresponding text 113 can be highlighted which may otherwise be overlooked if the textual quotation 109 and corresponding text 113 were presented alone without the additional contextual analysis results outputted by the context selector 114.

Furthermore, the arrangement of sections of the results GUI 306 can be specifically designed to improve readability while also optimizing computing resources. For instance, the arrangement of sections can be scalable to fit different display sizes and types, and can pull data directly from the backend operations of the subsystems 104 to improve data efficiency and reduce processing requirements of the device presenting the results GUI 306. Also, with this data processing architecture, any of the subsystems 104 can be replaced and/or upgraded as new NPL and LLM technology becomes available, while minimizing the negative impact on the frontend user interface. In other words, the way the results GUI 306 presents the data from the subsystems 104 can improve the efficiency of the textual data context assessment engine 102 by reducing the burden of frontend maintenance when backend upgrades to the subsystems 104 are made.

In some instances, the GUI 302 can include a textual assessment sidebar 332. The textual assessment sidebar 332 can include additional interactive GUI elements for controlling the presentation of data at the GUI 302. For instance, the textual assessment sidebar 332 can include a quotation type selector 334. The quotation type selector 334 can present one or more quotation type selection options 336, such as a matched quotation feature 338, an unmatched quotation feature 340, and/or an all quotations feature 342. A user input at the matched quotation feature 338 can cause the textual data context assessment engine 102 to filter a plurality of the textual quotations 109 identified by the statement identification subsystem 108 to create a filtered group of the textual quotations 109 including only textual quotations 109 that were matched with corresponding text 113 in the cited document 112, and present these matched textual quotations 109 at the results GUI 306. A user input at the unmatched quotation feature 340 causes the textual data context assessment engine 102 to determine all of the textual quotations 109 which do not have corresponding text 113 in a cited document 112, and present those results at the results GUI 306. A user input at the all quotations feature 342 can cause the results 306 to present every textual quotation 109 in the uploaded document 105 identified by the statement identification subsystem 108.

Additionally, the textual assessment sidebar 332 can include a quotation data differences filter 344. The quotation data differences filter 344 can include interactive GUI elements 346 to filter the amount and types of data of the context assessment responses 117 presented at the results GUI 306. For instance, the interactive GUI elements 346 of the quotation data differences filter 344 can include a potential mischaracterizations interactive element 348, which upon receiving a user input (e.g., an input at a checkbox), causes the results GUI 306 to present all of the assessment summaries 310 (e.g., a plurality of assessment summaries 310) corresponding to the textual quotations 109 selected from the quotation type selector 334. Another user input at an all textual differences element 350 can cause all textual differences between the textual quotation 109 and the corresponding text 113 to be presented a the results GUI 306, whereas a user input at the no textual differences element 352 can cause these textual differences to be omitted from the results GUI 306. Additionally, the textual assessment sidebar 332 can include a filter clearing element 354 which, responsive to a user input, causes the filters controlled by the textual assessment sidebar to clear/stop.

In some examples, the GUI 302 can also include a severity sort field 356 which can be used to sort the data presented at the results GUI 306 by potential severity of the potential mischaracterizations, with the highest potential severity being the default listed first. These severity levels can be determined by the response generator 116 when the response generator performs the comparisons between the legal proposition 110 of the upload document 105 and the context data 115 of the cited document 112, and/or the comparison between the textual quotation 109 and the corresponding text 113. For instance, comparisons that detect a higher degree of difference can be assigned a higher potential severity value and comparisons that detect a lower degree of difference can be assigned a lower potential severity value. A user input at the sort field 356 can cause the textual data context assessment engine 102 to retrieve these stored severity level values, sort the severity level values, and present the plurality of assessment summaries 310 in accordance with their corresponding sorted severity level values. In some situations, the sort field 356 can be omitted and the results GUI 306 can present the plurality of assessment summaries 310 in accordance with their corresponding sorted severity level values by default. Another option of the severity sort field 356 may be to sort the textual quotations 109 by the order in which they appear in the uploaded document 105. Furthermore, the GUI 302 can include a delivery method selector 358 which can be used to select which data to export and/or a format of data export. For instance, a user input at the delivery method selector 358 can select an option for exporting all of the assessment summaries 310, textual quotations 109, the corresponding texts 112, the legal proposition 110, the context data 115, and/or any combination thereof. Moreover, the user input at the delivery method selector 358 can cause the textual data context assessment engine 102 to determine a list format, or full report format for exporting the data.

FIG. 4 depicts an example system 100 for implementing the textual data context assessment engine 102 using a networked architecture 402. The system 100 depicted in FIG. 4 can be similar to, identical to, and/or can form at least a portion of the system(s) 100 depicted in FIG. 1-3.

In some examples, the system 100 can include one or more computing devices 404 forming the networked architecture 402. The computing device(s) 404 can include an edge computing device performing any or all of the operations locally, and/or a remote server device 406 hosting a service provider API or software that provides the textual data context assessment engine 102 as a “SaaS” (e.g., with any or all of the components or subsystems 104 of the textual data context assessment engine 102). Additionally or alternatively, the textual data context assessment engine 102 can be fully or partly deployed on-premises at a third-party server device, another third-party computing device (e.g., via integration into a third-party software platform 204) and/or integrated into circuitry of various hardware devices which may perform data processing. The textual data context assessment engine 102 may also be accessed remotely by and/or may send instructions to one or more external physical system(s) 408 (e.g., and/or external physical devices).

Moreover, in some instances, the computing device(s) 404 can include a computer, a personal computer, a desktop computer, a laptop computer, a terminal, a workstation, a cellular or mobile phone, a mobile device, a smart mobile device, a tablet, a wearable device (e.g., a smart watch, smart glasses, a smart epidermal device, etc.), a multimedia console, a television, an Internet-of-Things (IoT) device, a smart home device, a virtual reality (VR) device, an augmented reality (AR) device, a vehicle and/or a vehicle device, or the like.

In some examples, the computing device(s) 404 discussed herein can communicate via one or more network(s) 410 including any type of network, such as the Internet, an intranet, a Virtual Private Network (VPN), a Voice over Internet Protocol (VoIP) network, a wireless network (e.g., Bluetooth), a cellular network (e.g., 4G, LTE, 5G, 6G, etc.), a satellite network, combinations thereof, etc. The network(s) 410 can include communications network(s) with numerous components, such as gateways routers, server(s) 406, and registrars, which enable communication across the network 410. In one implementation, the communications network(s) includes multiple ingress/egress routers, which may have one or more ports, in communication with the network 410. Additionally, or alternatively, the computing device(s) 404 and/or the server(s) 406 can access and be accessed by the network 410 via another type of communications network, which may be a public switched telephone network (PSTN) operated by a local exchange carrier (LEC).

In some instances, at least one server 406 can host a website or application of the textual data context assessment engine 102, such as a web client application and/or a download link, to provide access to the various subsystems 104 and/or GUIs disclosed herein (e.g., the data file upload subsystem 106, the statement identification subsystem 108, the cited document validator 111, the context selector 114, the response generator 116, the GUIs 202, and/or the GUIs 302, such as the results GUI 306). The computing device(s) 404 may visit the hosted website to access the textual data context assessment engine 102 and/or to send inputs to the textual data context assessment engine 102. To perform the operations disclosed herein, the server(s) 406 and/or the edge computing device can access (e.g., read and/or write) one or more database(s) 412. Additionally or alternatively, some or all of the software components of the textual data context assessment engine 102 disclosed herein can be stored and/or executed locally at the edge computing device. An application of the textual data context assessment engine 102 can receive the inputs and can analyze the inputs to generate the outputs discussed herein, which can be stored at the database(s) 412.

Furthermore, the server 406 may be a single server, a plurality of servers with each server being a physical server or a virtual machine, or a collection of both physical servers and virtual machines. In another implementation, the textual data context assessment engine 102 hosts components of the subsystems 104 (e.g., the data file upload subsystem 106, the statement identification subsystem 108, the cited document validator 111, the context selector 114, the response generator 116, and/or any combination) on separate servers 406 operating in parallel. The server(s) 406 may represent an instance among large instances of application servers in a cloud computing environment, a data center, or other computing environment.

Additionally, the computing device 404 may be a computing system capable of executing a computer program product to execute a computer process. Data and program files may be input to the computing device 404, which reads the files and executes the programs therein. Some of the elements of the computing device 404 can include one or more hardware processors 414, one or more memory devices 416, and/or one or more ports, such as input/output (IO) port(s) 418 and communication port(s) 420. Various elements of the computing device 404 may communicate with one another by way of the communication port(s) 420 and/or one or more communication buses, point-to-point communication paths, or other communication means.

The processor 414 may include, for example, a central processing unit (CPU), a microprocessor, a microcontroller, a digital signal processor (DSP), a graphics processing unit (GPU), a quantum processor, and/or one or more internal levels of cache. There may be one or more processors 414, such that the processor 414 comprises a single processing unit, or a plurality of processing units capable of executing instructions and performing operations in parallel with each other, referred to as a parallel processing environment, which can be across multiple CPUs and/or GPUs.

The computing device 404 may be a single computer, a plurality of computers (e.g., a distributed computer), or another type of computer, such as one or more external computers made available via the cloud computing architecture. The presently described technology is optionally implemented in software stored on a data storage device(s) such as the memory device(s) 416 (e.g., locally stored at the computing device 404), and/or communicated via one or more of the ports 418 or 420, thereby transforming the computing device 404 into a special-purpose machine for generating outputs indicating mischaracterizations of textual quotations 109, and/or for sending control instructions 422 to external physical systems 408 (e.g., control systems and/or control processors of the external physical systems 408) to perform automated physical actions responsive to the outputs of the textual data context assessment engine 102.

For instance, the external physical systems 408 may include a printer, and the control instruction 422 (e.g., control signal) can be sent to the printer to generate a physical paper copy of the context assessment response 117 (e.g., and/or any of the information presented at the results GUI 306). The external physical systems 408 may include a visual alert system with one or more lights or light emitting diodes (LED), and the textual data context assessment engine 102 can send a control instruction 422 to the visual alert system to cause a particular LED or light to illuminate responsive to the detection of the mischaracterization of the textual quotation 109 in the context assessment response 117. For example, one color LED (e.g., red) may illuminate to represent the presence of the mischaracterization, whereas another color (e.g., green), may illuminate to represent the absence of a mischaracterization. In some cases, the control instructions 422 may be sent to a visual display monitor to cause particular pixels to illuminate in response to the outputs of the textual data context assessment engine 102. Furthermore, the external physical system 408 may include an audio speaker, and the control instruction 422 can cause the audio speaker to generate a particular audio alert indicating the presence or absence of the mischaracterization.

Moreover, in some cases, the computing device 404 may comprise a special-purpose device with particular hardware components specifically combined together, such that the special-purpose device is designed to implement the textual data context assessment engine 102 to provide a real-time, low-computational overhead, highly energy efficient assessment of whether the textual quotation 109 mischaracterizes the context data 115, (e.g., by using one or more of the control instruction(s) 422). For instance, the computing device 404 can include a camera for receiving the input data 107 as image data, a microphone for receiving the input data 107 as audio data, a light to be illuminated in response to the outputs, and/or a microphone to generate an audio alert in response to the outputs. This type of special-purpose device may include a simplified printed circuit board (PCB) to integrate these components together and can be designed with a minimal form factor for use in a judge's chamber and/or at a law firm to provide quick, low-processing, energy efficient, assessments of high volumes of textual data using the textual data context assessment engine 102. Moreover, these types of special-purpose devices may be useful in education settings for instructors to generate highly efficient assessments of student work product which includes textual quotations 109.

The one or more memory device(s) 416 may include any non-volatile data storage device capable of storing data generated or employed within the computing device 404, such as computer executable instructions for performing a computer process, which may include instructions of both application programs and an operating system (OS) that manages the various components of the computing device 404. The memory device(s) 416 may include magnetic disk drives, optical disk drives, solid state drives (SSDs), flash drives, and the like. The memory device(s) 416 may include removable data storage media, non-removable data storage media, a quantum memory device, and/or external storage devices made available via a wired or wireless network with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 416 may include volatile memory (e.g., dynamic random-access memory (DRAM), static random-access memory (SRAM), etc.) and/or non-volatile memory (e.g., read-only memory (ROM), flash memory, etc.).

The memory device(s) 416 which may be referred to as machine-readable media which can include tangible non-transitory medium capable of storing or encoding instructions to perform operations of the system 100 disclosed herein. The machine-readable media can store computer-readable instructions for execution by a machine, and/or can be capable of storing or encoding data structures and/or algorithmic modules utilized by or associated with such instructions.

In some implementations, the computing device 404 can include one or more ports, such as the I/O port 418 and the communication port 420, for communicating with other computing, network, or devices. It will be appreciated that the I/O port 418 and the communication port 420 may be combined or separate and that more or fewer ports may be included in the computing device 404.

The I/O port 418 may be connected to an I/O device, or other device, by which information is input to or output from the computing device 404. For instance, input devices can convert a human-generated signal, such as human voice, physical movement, physical touch or pressure, and/or the like, into electrical signals as input data into the computing device 404 via the I/O port 418. Similarly, output devices may convert electrical signals received from the computing device 404 via the I/O port 418 into signals that may be sensed as output by a human, such as sound, light, and/or touch, or may be converted into the control instructions 422. The input device may be an alphanumeric input device, including alphanumeric and other keys for communicating information and/or command selections to the processor 414 via the I/O port 418. The input device may be another type of user input device including direction and selection control devices, such as a mouse, a trackball, cursor direction keys, a joystick, a wheel, and/or one or more sensors, such as a camera, a microphone, a positional sensor, an orientation sensor, an inertial sensor, an accelerometer; and/or a touch-sensitive display screen (“touchscreen”). The output devices may include, without limitation, a display, a touchscreen, a speaker, a tactile or haptic output device, and/or the like. In some implementations, the input device and the output device may be the same device, for example, in the case of a touchscreen.

In some examples, the communication port 420 can be connected to the network 410, and the computing device 404 may receive network data useful in executing the methods and systems set out herein as well as transmitting information and network configuration changes determined thereby. Stated differently, the communication port 420 can connect the computing device 404 to one or more communication interface devices configured to transmit and/or receive information between the computing device 404 and other devices by way of one or more wired or wireless communication networks or connections. Examples of such networks connections include Universal Serial Bus (USB), Ethernet, Wi-Fi, Bluetooth®, Near Field Communication (NFC), or any other network connection interface of the network 410. For instance, one or more such communication interface devices may be utilized via the communication port 420 to communicate with one or more other machines, either directly over a point-to-point communication path, over a wide area network (WAN) (e.g., the Internet), over a local area network (LAN), over a cellular network, over an intelligent transport system (ITS) or over another communication means. Further, the communication port 420 may communicate with an antenna or other link for electromagnetic signal transmission and/or reception.

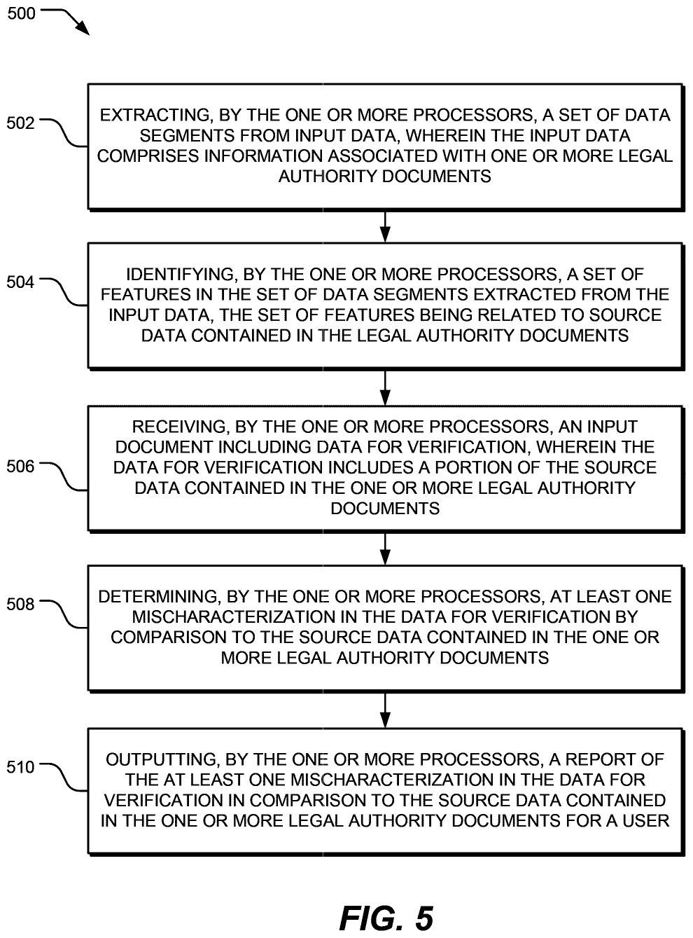

FIG. 5 depicts an example method 500 of performing a textual quotation assessment procedure by using the textual data context assessment engine 102. The method 500 can be implemented by the system(s) 100 discussed above regarding FIG. 1-4.

In some instances, at operation 502, the method 500 can extract, by the one or more processors, a set of data segments from input data, wherein the input data comprises information associated with one or more legal authority documents. At operation 504, the method 500 can identify, by the one or more processors, a set of features in the set of data segments extracted from the input data, the set of features being related to source data contained in the legal authority documents. At operation 506, the method 500 can receive, by the one or more processors, an input document including data for verification, wherein the data for verification includes a portion of the source data contained in the legal authority documents. At operation 508, the method 500 can determine, by the one or more processors, at least one mischaracterization in the data for verification by comparison to the data contained in the legal authority documents. At operation 510, the method 500 can output, by the one or more processors, a report of the at least one mischaracterization in the data for verification in comparison to the source data contained in the legal authority documents for a user.

It is to be understood that the specific order or hierarchy of steps in the methods depicted throughout this disclosure are instances of example approaches and can be rearranged while remaining within the disclosed subject matter. For instance, any of the operations discussed throughout this disclosure may be omitted, repeated, performed in parallel, performed in a different order, and/or combined with any other of the operations discussed throughout this disclosure.

While the present disclosure has been described with reference to various implementations, it will be understood that these implementations are illustrative and that the scope of the present disclosure is not limited to them. Many variations, modifications, additions, and improvements are possible. Functionality may be separated or combined differently in various implementations of the disclosure or described with different terminology. Any feature from any of the examples disclosed herein can be combined with any other feature of any example. These and other variations, modifications, additions, and improvements may fall within the scope of the disclosure as defined in the claims that follow.

What is claimed is:

1. A system comprising,
a memory; and
one or more processors coupled to the memory, the one or more processors configured to perform steps, comprising:
extracting, by the one or more processors, a set of data segments from input data, wherein the input data comprises information associated with one or more legal authority documents;
identifying, by the one or more processors, a set of features in the set of data segments extracted from the input data, the set of features being related to source data contained in the legal authority documents;
receiving, by the one or more processors, an input document including data for verification, wherein the data for verification includes a portion of the source data contained in the one or more legal authority documents;
determining, by the one or more processors, at least one mischaracterization in the data for verification by comparison to the source data contained in the one or more legal authority documents; and
outputting, by the one or more processors, a report of the mischaracterization in the data for verification in comparison to the source data contained in the one or more legal authority documents for a user.

2. The system of claim 1, wherein:
the input document includes a textual document uploaded to a textual data context assessment engine executed by the one or more processors.

3. The system of claim 2, wherein:
the data for verification includes one or more textual quotations and one or more citations associated with the one or more textual quotations.

4. The system of claim 3, wherein:
the one or more processors are further configured to perform steps comprising executing a natural language processor that uses a set of position and distance rules to identify a legal proposition corresponding to the one or more textual quotations.

5. The system of claim 4, wherein:
the set of features includes data from a cited document which corresponds to the data for verification.

6. The system of claim 5, wherein:
the determining of the at least one mischaracterization in the data for verification includes providing the set of features and the data for verification to a large language model (LLM) with a prompt to identify any mischaracterizations between the set of features and the data for verification.

7. The system of claim 6, wherein:
the prompt includes a formatting instruction to generate an output having a length of two to four lines.

8. The system of claim 1, wherein:
the one or more processors are further configured to perform steps comprising generating a graphical user interface (GUI) to present a visualization of the report.

9. The system of claim 8, wherein:
the GUI includes a first section that presents an assessment summary of the report and one or more additional sections which present at least one of the set of features or the data for verification.

10. A system comprising,
a memory; and
one or more processors coupled to the memory, the one or more processors configured to perform steps comprising:
identifying, by the one or more processors, data for verification from an uploaded data file representing an input document, the data for verification including at least a textual quotation, a legal proposition, and a citation related to a cited document;
extracting, by the one or more processors, a set of data segments from input data corresponding to the cited document;
identifying a set of features in the set of data segments extracted from the input data, the set of features including context data corresponding to a legal authority document;
determining, by the one or more processors, at least one relationship between the data for verification by comparison to the set of features; and
outputting, by the one or more processors, a report of the at least one relationship between the data for verification in comparison to the context data for a user.

11. The system of claim 10, wherein:
the one or more processors are configured to perform steps comprising causing a graphical user interface (GUI) to be presented at a display of a computing device, the GUI presenting a visual representation of one or more portions of the report.

12. The system of claim 11, wherein:
the GUI includes a first section including an assessment summary of the report indicating the at least relationship, the at least one relationship including a mischaracterization of the cited document in the data for verification.

13. The system of claim 12, wherein:
the GUI includes a first column of presented data and a second column of presented data, the first column includes data from the input document and the second column includes data from the cited document, and the first column and the second column are arranged at the GUI below the first section including the assessment summary.

14. The system of claim 13, wherein:
the first column includes a visual presentation of the data for verification.

15. The system of claim 14, wherein:
the visual presentation of the data for verification includes a first visual indicator of the textual quotation and a second visual indicator of the legal proposition.

16. The system of claim 13, wherein:
the second column includes a visual presentation of the set of features from the input data.

17. The system of claim 16, wherein:
the visual presentation of the set of features includes a first visual indicator of corresponding text from the cited document and a second visual indicator of context data associated with the corresponding text.

18. The system of claim 17, wherein:
the GUI includes presentation of a quotation type selector element which, upon receiving a user input, causes textual quotations presented at the GUI to be filtered based on whether the textual quotations are matched, by the one or more processors, with corresponding texts from cited documents.

19. The system of claim 16, wherein:
the GUI includes presentation of a severity sort element which, upon receiving user input, sorts a plurality of textual quotations presented a the GUI based on potential severity of mischaracterization values associated with a plurality of textual quotations.

20. A method comprising:
extracting, by one or more processors, a set of data segments from input data, wherein the input data comprises information associated with one or more legal authority documents;
identifying, by the one or more processors, a set of features in the set of data segments extracted from the input data, the set of features being related to source data contained in the legal authority documents;
receiving, by the one or more processors, an input document including data for verification, wherein the data for verification includes a portion of the source data contained in the legal authority documents;
determining, by the one or more processors, at least one of an omission, an addition, a change, or accurate characterization in the data for verification by comparison to the source data contained in the legal authority documents; and
outputting, by the one or more processors, a report of the at least one of the omission, the addition, or the change in the data for verification in comparison to the source data contained in the legal authority documents for a user.
